(19) United States
(12) Patent Application Publication
(10) Pub. No.: US 2008/0021902 A1
(43) Pub. Date: Jan. 24, 2008

(54) System and Method for Storage Area Network Search Appliance

(76) Inventors: William P. Dawkins, Austin, TX (US); Sadiq Ahamed Shaik, Bangalore (IN)

Correspondence Address: HAMILTON & TERRILE, LLP, P.O. BOX 203518, AUSTIN, TX, 78720, US

(21) Appl. No.: 11/458,144

(22) Filed: Jul. 18, 2006

(51) Int. Cl. G06F 17/30

(52) U.S. Cl. 707/10

(57) ABSTRACT

A search engine maintains a search index of information stored on a storage area network by analyzing the stored information through a connection with the storage area network. An indexing module distributed from the search engine, such as in RAID controllers, intelligent switches and storage server information handling systems, analyzes writes to storage devices of the storage area network to determine changes in the storage index due to the writes and communicates the index updates to the search engine. Alternatively, a mirroring application mirrors a copy of the writes to the search engine so the search engine can update the search index. Client information handling systems interface with the search engine through the storage area network connection or through a separate local area network connection.

### BACKGROUND OF THE INVENTION

1. Field of the Invention

The present invention relates in general to the field of information handling system storage area networks, and more particularly to a system and method for a storage area network search appliance.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The wide acceptance of information handling systems as business and personal tools has resulted in the generation of large quantities of information, such word processing documents, spreadsheets, databases and Internet Web pages. Problems presented by the generation of large quantities of information include storage of the information and finding desired information after it is stored. Generally, business prefer to use centralized databases to store information so that multiple client information handling systems interfaced through a local area network (LAN) can access the information. However, the amount of information generated by a business is often considerable and tends to increase over time. Storage area networks (SANs) provide a convenient and flexible architecture for addressing information storage needs as the needs evolve and change. Multiple storage devices, such as hard disk drives in a RAID configuration, are interfaced with each other through a network structure, such as a fibre channel. One or more storage server information handling systems interfaced with the network structure direct the writing and retrieval of information at the storage devices. The storage server information handling systems interface with a LAN to provide access by client information handling systems associated with the LAN to the information stored on the SAN. Storage capacity is easily increased by adding additional storage devices to the SAN network architecture.

Although a variety of techniques are available for locating information stored on a SAN, a popular technique that provides relatively quick information location is indexing by a search engine. Search engine indexing technology is often used by Internet companies to track information stored on the Internet. Internet search engines continuously crawl through available Web pages and create an index of information stored on the Web pages. The index provides a rapid way to determine which Web pages have information associated with a desired search request. Similarly, SAN search engines access the SAN from the LAN to retrieve information and generate an index of the information stored on the SAN. The index allows client information handling systems on the LAN to quickly locate information associated with desired search terms. However, such search engines place a burden on the LAN where large quantities of information are retrieved for indexing, such as when information is migrated to different locations. In some instances, volumes on a SAN are not exposed to search engines on the LAN, such as where a SAN server used by the LAN lacks access to a volume, where a volume is “orphaned” and thus not visible, or where information is stored on near-line storage devices and tape storage devices which are not generally visible through a LAN. One attempt to address these issues is the Index Engines' Enterprise Search Appliance which uses backup software associated with the SAN to identify changes to stored information. However, only backed-up information is indexed and delays are introduced to the index based on the timing of backups.

### SUMMARY OF THE INVENTION

Therefore a need has arisen for a system and method which searches information stored on a SAN from within the SAN's network architecture.

In accordance with the present invention, a system and method are provided which substantially reduce the disadvantages and problems associated with previous methods and systems for searching information stored on a SAN. A search engine located at the SAN maintains a search index with distributed index updates. The search index updates are performed when writes are made to the SAN so that a current search index is maintained,

More specifically, client information handling systems interface through a LAN with a storage area network to store and retrieve information with logical addresses at storage devices managed by storage server information handling systems. A search engine connects directly with the SAN to maintain a search index of information stored at the SAN and also connects directly to the LAN to provide access to searches by the client information handling systems. Search index updating functionality is distributed throughout SAN hardware devices, such as RAID controllers, intelligent switches and server information handling systems, to maintain the search index up to date. For instance, indexing modules monitor I/O commands at associated hardware devices to detect writes that result in changes to information stored at the hardware devices. The write is analyzed by the indexing module to determine the changes made by the write to the search index and the changes to the search index are forwarded to the search engine for updating the search index. As another example, a mirroring application monitors I/O commands at associated hardware devices to generate a mirror copy of each write command. The mirror copy of the write is forwarded to the search engine so that the search engine analyzes the mirror copy for updating the search index. The mirror copy of the write is then discarded.

The present invention provides a number of important technical advantages. One example of an important technical advantage is that search engine indexing supported from SAN network architecture provides accurate and timely search indexes with reduced burden on LAN accesses to the SAN. The search engine is implemented with standard hardware deployed within the SAN architecture. Index applications that help build a search index are implemented with firmware or software modules deployed to storage devices, such as RAID controllers. Alternatively, mirroring applications prepare mirror writes to the search engine which are used to generate the index and then discarded. Generation of the index as writes occur provide up to date searches that encompass the entirety of the information stored on the SAN, including migrated volumes, volumes not accessible by the LAN, orphaned volumes, near-line storage devices and tape storage devices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for managing information stored on a storage area network; and

FIG. 2 depicts a flow diagram of a process for managing information stored on a storage area network.

### DETAILED DESCRIPTION

Distributing search engine indexing functions in a storage area network manages stored information with reduced burden on networking and information handling system assets. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

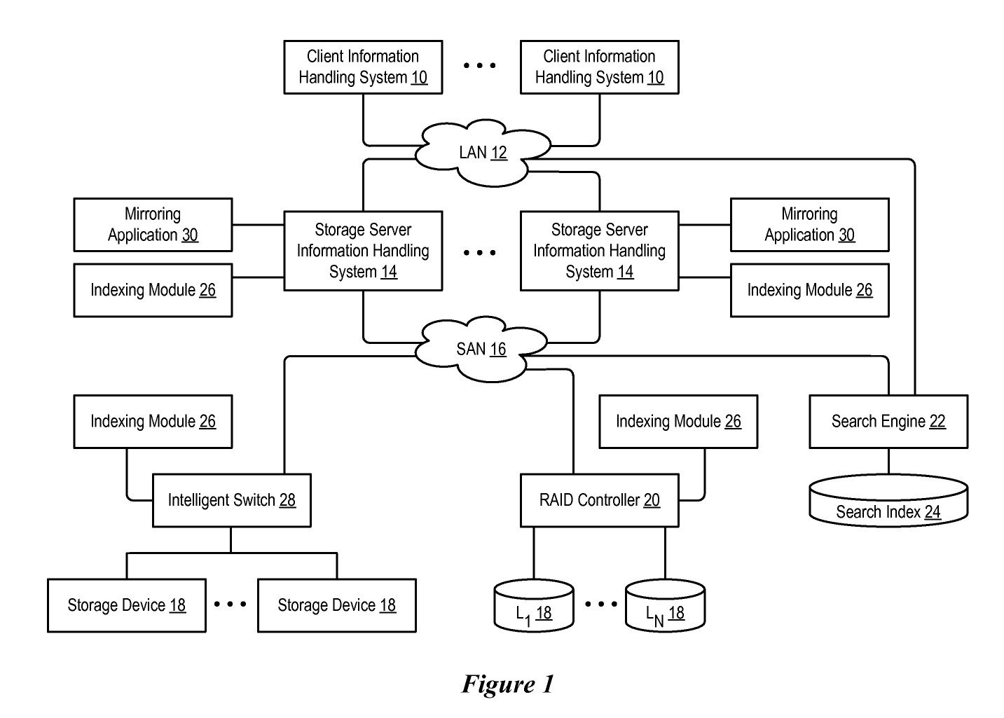

Referring now to FIG. 1, a block diagram depicts a system for managing information stored on a storage area network. Plural client information handling systems 10 interact through a local area network 12 and storage server information handling systems 14 with a storage area network 16. Storage area network 16 has a plurality of storage devices 18 that store information under the direction of storage server information handling system 14. For instance, storage devices 18 include a plurality of hard disk drives combined by a RAID controller 20 into RAID volumes. Alternatively, storage devices 18 include tape drives or near-line storage devices. Client information handling systems 10 access information from storage area network 16 by communicating requests for information through local area network 12 to storage server information handling systems 14 with a logical addressing system. Client information handling systems 10 write information to storage area network 16 by sending write requests through local area network 12 to a storage server information handling system 14, which determines the logical address and storage device 18 to manage the write.

Storage area network 16 provides a flexible and scalable solution to information storage by supporting the addition or removal of storage devices 18 as additional storage is needed or as storage devices become outdated. Since storage area network 16 potentially stores large quantities of information, a search engine 22 offers an attractive solution for managing and finding stored information. Search engine 22 connects directly to storage area network 16 and manages stored information through a search index 24. For instance, search requests from client information handling systems 10 to search engine 22 through storage area network 16 or through a separate connection directly to local area network 12 are compared against search index 24 to identify stored information having the search request terms. Accurate searches of the stored information depend upon the existence of an accurate search index 24. Search engine 22 will miss relevant information if the information is not properly indexed. To maintain a current search index 24, a conventional search engine 22 crawls through the information stored on storage area network 16 to identify index terms with the crawling performed from a connection through LAN 12, thus often missing information unavailable through LAN 12 and sometimes having non-current information.

In order to provide a more accurate and up to date search index 24, search engine 22 is deployed with a direct connection to storage area network 16 and indexing functions are distributed at various locations of storage area network 16. A direction connection to storage area network 16 allows search engine 22 to update search index 24 without burdening local area network 12. A separate direct connection to local area network 12 allows search engine 22 to support search requests from client information handling systems 10 without burdening storage area network 16. Indexing modules 26 distributed to run on various hardware devices in storage area network 16, such as storage servers 14, RAID controllers 20 or intelligent switches 28, provides index update changes to search index 24 without search engine 22 directly retrieving information for analysis. Indexing module 26 monitors incoming I/O commands storage devices under its management. When a write command is detected to an associated storage device, indexing module 26 analyzes the information of the write to determine what changes the write will generate to search index 24, such as for a particular volume of storage. Indexing module 26 then sends the index update determined for search index 24 based on the write to search engine 22. Search engine 22 updates search index 24 based upon the changes sent from indexing module 26.

Distribution of indexing modules 26 to plural hardware components within storage area network 16 provides an efficient solution for updating search index 24 since the amount of information retrieved by search engine 24 across storage area network 16 is reduced. For example, search index updates generally have less size than the underlying information and therefore consume less bandwidth of storage area network 16 than is consumed by retrieval of the information by search engine 22. As an alternative, however, mirroring applications 30 may be deployed for some or all hardware components instead of indexing modules 26. Each write managed by a hardware component having a mirroring application 30 has a mirror copy generated by mirroring application 30 and forwarded to search engine 22. Search engine 22 analyzes the mirror copy just as if the information were retrieved directly by search engine 22 and updates search index 24 to reflect the write. Search engine 22 may discard the mirror copy after the update is complete. The mirror copy provided by mirroring application 30 keeps search index 24 up to date without having to have search engine 22 retrieve unchanged information through the crawling process. Thus, the overall amount of information sent across storage area network 16 needed to maintain search index 24 current is still reduced compared with the conventional crawling process. After search engine 22 analyzes the mirror copy to determine the update to search index 24, the mirror copy is discarded.

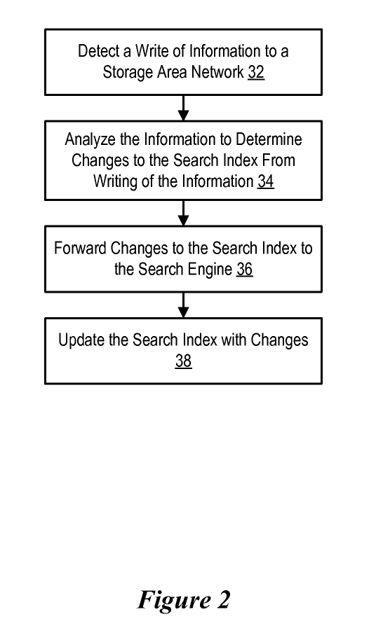

Referring now to FIG. 2, a flow diagram depicts a process for managing information stored on a storage area network. The process begins at step 32 with the detection of a write of information to a storage area network. At step 34, the information is analyzed to determine changes to the search index from the writing of the information. The changes to the search index are determined with software or firmware running on a device within the storage area network, such as a storage server, an intelligent switch or a RAID controller. At step 36, the changes to the search index are forwarded from the device that detected the write to the search engine. At step 38, the search engine updates the search index with the changes so that the search index will incorporate the new write of information to the storage area network. The search index thus remains up to date even though the search engine is not performing a crawling operation to update the search index.

Although the present invention has been described in detail, it should be understood that various changes, substitutions and alterations can be made hereto without departing from the spirit and scope of the invention as defined by the appended claims.

What is claimed is:

1. A system for storing information, the system comprising:
one or more client information handling systems operable to generate information for storage;
a local area network interfaced with the client information handling systems and operable to communicate information;
one or more storage server information handling systems interfaced with the local area network and operable to receive information from the client information handling systems for storage;
a storage area network interfaced with the storage server information handling systems and operable to communicate information;
one or more storage devices interfaced with the storage area network and operable to store information provided from the storage server information handling system;
a search engine interfaced with the storage area network, the search engine operable to maintain an index of information stored on the storage devices; and
an indexing module associated with the storage area network, the indexing module operable to detect writes of information to the storage devices and to forward index updates to the search engine, the index updates operable to support updates to the index for the detected writes.

2. The system of claim 1 wherein the indexing module index updates comprise the change to the index caused by the write.

3. The system of claim 1 wherein the storage devices comprise a RAID controller and the indexing module runs on the RAID controller.

4. The system of claim 1 wherein the storage area network comprises a switch having a processor and the indexing module runs on the switch.

5. The system of claim 1 wherein the indexing module comprises a mirroring application operable to copy each write and the index updates comprise a copy of each write sent to the search engine, the search engine operable to analyze the write to update the index.

6. The system of claim 5 wherein the mirroring application runs on the storage server information handling system.

7. The system of claim 5 wherein the search engine is further operable to discard the copy of the write after analyzing the write to update the index.

8. The system of claim 1 wherein the search engine further interfaces with the local area network to perform searches for client information handling systems.

9. A method for managing information stored on a storage area network having plural storage devices, the method comprising:
generating information for storage with an information handling system client of a local area network;
communicating the information through the local area network to a storage area network having plural storage devices;
storing the information on one or more of the storage devices;
determining within the storage area network a change to a search engine index based upon the one or more storage devices that store the information; and
updating the search engine index with the determined change.

10. The method of claim 9 wherein the storage device comprises a RAID volume.

11. The method of claim 9 wherein determining within the storage area network a change to a search engine index further comprises determining the change to the search engine index with an indexing module associated with the storage device.

12. The method of claim 11 wherein the storage device comprises a RAID controller.

13. The method of claim 11 wherein the storage device comprises an intelligent switch.

14. The method of claim 11 wherein the storage device comprises a storage server information handling system.

15. The method of claim 9 wherein determining within the storage area network a change to a search engine index further comprises:
generating a mirror copy of the information;
sending the mirror copy to the search engine; and
analyzing the mirror copy of the information with the search engine to determine the change to the index.

16. The method of claim 9 further comprising:
connecting the search engine to both the local area network and the storage area network; and
communicating search requests between the local area network and the search engine.

17. A system for managing information at a storage area network, the system comprising:
a search engine connected to the storage area network, the search engine having a search index of information stored on the storage area network; and
an indexing module distributed from the search engine and running on a device of the storage area network, the indexing module operable to generate a change to the search index for writes of information to the storage area network and to communicate the change to the search index through the storage area network to the storage engine for updating the search index.

18. The system of claim 17 wherein the device running the indexing module comprises a RAID controller.

19. The system of claim 17 wherein the device running the indexing module comprises an intelligent switch.

20. The system of claim 17 wherein the device running the indexing module comprises a storage server information handling system.
